(19) United States
(12) Patent Application Publication
(10) Pub. No.: US 2015/0253879 A1
(43) Pub. Date: Sep. 10, 2015

(54) Data Processing Device

(71) Applicant: Brother Kogyo Kabushiki Kaisha, Nagoya-shi (JP)

(72) Inventor: Mina Kawai, Nagoya-shi (JP)

(21) Appl. No.: 14/580,253

(22) Filed: Dec. 23, 2014

(30) Foreign Application Priority Data
Mar. 5, 2014 (JP) 2014-042806

(51) Int. Cl. G06F 3/0354; G06F 3/0488

(52) U.S. Cl. CPC G06F 3/03545; G06F 3/04883

(57) ABSTRACT

A data processing device includes a detection portion, a processor, and a memory. The detection portion is configured to detect a position of a writing tool being close to a detection area. The memory is configured to store computer-readable instructions. The computer-readable instructions, when executed by the processor, cause the data processing device to perform processes that include acquiring first data being coordinate data indicating positions in a first area, determining whether an instruction to end acquisition of the first data is received, acquiring second data being coordinate data indicating positions detected after it is determined that the instruction is received, storing, in a first storage portion, area information indicating a plurality of areas, acquiring third data being coordinate data indicating a position, in a second area, that is detected after the second data is acquired, and determining an order of the plurality of areas using an ordering method.

### CROSS-REFERENCE TO RELATED APPLICATION

This application claims priority to Japanese Patent Application No. 2014-042806 filed Mar. 5, 2014, the content of which is hereby incorporated herein by reference.

### BACKGROUND

The present disclosure relates to a data processing device that can digitize a trajectory of a writing tool based on a writing operation on a paper medium.

A data processing device is known that can digitize a trajectory of a writing tool based on an operation of the writing tool that is used to perform writing on a paper medium that is placed on a placement portion. For example, a known electronic writing device generates stroke data based on coordinate information that indicates a plurality of positions of a pen tip when an electronic pen is used to perform writing on a paper medium placed on a placement portion. For example, a user may use the electronic pen to perform writing in a writing area on the paper medium. After that, on the paper medium, the user may perform writing that checks a check box to specify a folder and a check box to instruct saving. In this case, the above-described device saves the stroke data that is based on the writing performed in the writing area, in the specified folder.

### SUMMARY

When the writing that checks the check box to instruct saving is performed on the paper medium, the above-described device saves the stroke data that is based on the writing performed in the writing area, as it is. Therefore, the above-described device cannot perform ordering of a plurality of line drawings that have been written in the writing area before the writing that checks the check box to instruct saving is performed.

Embodiments of the broad principles derived herein provide a data processing device that can order at least a part of line drawings that are written in a writing area, in an order desired by a user.

Embodiments provide a data processing device that includes a detection portion, a processor, and a memory. The detection portion is configured to detect a position of a writing tool being close to a detection area. The detection area is configured such that a paper medium can be placed thereon. The memory is configured to store computer-readable instructions. The computer-readable instructions, when executed by the processor, cause the data processing device to perform processes that include acquiring first data, the first data being coordinate data indicating positions, in a first area, that are detected by the detection portion, the first area being a predetermined area in the detection area, and the first data indicating a plurality of line drawings written on the paper medium, determining whether an instruction to end acquisition of the first data is received, acquiring second data, the second data being coordinate data indicating positions detected by the detection portion after it is determined that the instruction is received, the second data indicating a plurality of surrounding line drawings, and each of the plurality of surrounding line drawings being a line drawing that surrounds at least a part of the plurality of line drawings, storing area information in a first storage portion, the area information indicating a plurality of areas that are identified based on the plurality of surrounding line drawings indicated by the acquired second data, acquiring third data, the third data being coordinate data indicating a position, in a second area, that is detected by the detection portion after the second data is acquired, the second area being a predetermined area that is in the detection area and that is different from the first area, and the third data indicating an ordering method of the plurality of areas, and determining an order of the plurality of areas using the ordering method indicated by the acquired third data.

### BRIEF DESCRIPTION OF THE DRAWINGS

Embodiments will be described below in detail with reference to the accompanying drawings in which:

FIG. 1 is a diagram showing an overview of a handwriting input system;

FIG. 2 is a block diagram showing an electrical configuration of a reading device and a smart phone;

FIG. 3 is a diagram showing a paper sheet that is mounted on the reading device;

FIG. 4 is a diagram showing a table;

FIG. 5 is a diagram showing an image;

FIG. 6 is a diagram showing an image;

FIG. 7 is a flowchart of main processing;

FIG. 8 is a flowchart of image file creation processing;

FIG. 9 is a flowchart of the image file creation processing, and is a continuation of FIG. 8; and

FIG. 10 is a flowchart of data conversion processing.

### DETAILED DESCRIPTION

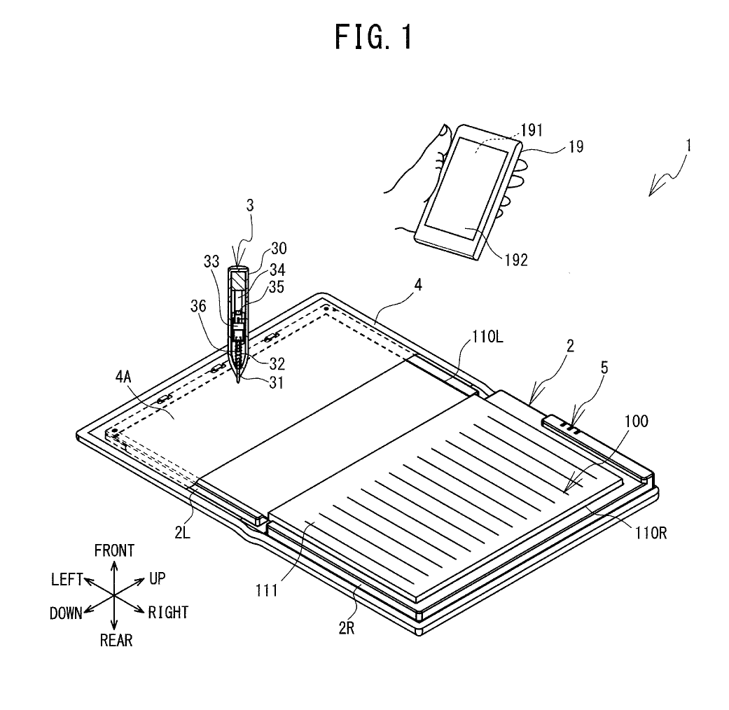

Hereinafter, an embodiment will be explained with reference to the drawings. An overview of a handwriting input system 1 according to the present embodiment will be explained with reference to FIG. 1. In the explanation that follows, the upper left side, the lower right side, the top side, the bottom side, the upper right side, and the lower left side in FIG. 1 are respectively the left side, the right side, the front side, the rear side, the top side, and the bottom side of a reading device 2.

As shown in FIG. 1, the handwriting input system 1 mainly includes the reading device 2, an electronic pen 3, and a smart phone 19. The reading device 2 is a thin and lightweight handwriting input device that is portable and can be folded. A paper medium 100 may be mounted on the reading device 2. In the handwriting input system 1, a user may use the electronic pen 3 to write a point and a line drawing on a paper sheet 111 of the paper medium 100. Hereinafter, an explanation will be given for a case in which a line drawing is written. The line drawing includes a character, a number, a mark, a graphic, and the like. The reading device 2 acquires positions of the electronic pen 3 in the course of writing. Based on the acquired positions, the reading device 2 identifies a line drawing that is written on the paper sheet 111 using the electronic pen 3. The reading device 2 creates an image file of an image that includes the identified line drawing. The reading device 2 can transmit the created image file to the smart phone 19. When the image file is received, the smart phone 19 displays an image that corresponds to the received image file on a display 192. Thus, the user can visually check, via the display 192, a line drawing that has the same shape as the line drawing written on the paper sheet 111 using the electronic pen 3.

The reading device 2 mainly includes a left reading device 2L and a right reading device 2R, which form a left-right pair, and a cover 4. The left reading device 2L and the right reading device 2R are each shaped as a thin rectangular plate. The left reading device 2L and the right reading device 2R are disposed such that they can be opened out to a two-page spread in the left-right direction on the front face of the cover 4. The left reading device 2L and the right reading device 2R are electrically connected by a flat cable (not shown in the drawings). The right reading device 2R is provided with three light-emitting diodes (LEDs) 5 along its top edge. The LEDs 5 can notify the user as to the state of the reading device 2. The cover 4 includes a pouch-shaped pouch portion 4A on its left side. The left reading device 2L is removably mounted in the cover 4 by being inserted into the pouch portion 4A. The right reading device 2R is affixed to the right front face of the cover 4 by double-sided tape, an adhesive resin film, or the like.

The paper medium 100 may be removably mounted on the front face of the reading device 2. The paper medium 100 has a booklet shape that can be opened out to a two-page spread in the left-right direction. In the paper medium 100, a pair of covers (a front cover 110L and a back cover 110R) and a plurality of forms 111 are bound by a part of their edges. For example, the paper medium 100 may be an AS size notebook. A format of the form 111 indicates the layout and the like of a pattern that is printed on the form 111 in advance. The format of the form 111 differs according to the type of the paper medium 100. The format of the form 111 may be different on each page. The paper medium 100 is mounted on the reading device 2 such that the front cover 110L is placed on the front face of the left reading device 2L and the back cover 11OR is placed on the front face of the right reading device 2R. In the present embodiment, the paper medium 100 is mounted in a state in which the paper medium 100 is positioned on the reading device 2 by double-sided tape, an adhesive resin film, or the like. In other words, the left reading device 2L and the right reading device 2R may move as a single unit with the front cover 110L and the back cover 110R, respectively. The user may use the electronic pen 3 to write a line drawing on the form 111 of the paper medium 100. The reading device 2 may include the right reading device 2R only. In this case, the paper medium 100 that can be mounted on the reading device 2 is AS size notebook paper, for example.

The electronic pen 3 is a known electromagnetic induction-type of electronic pen and mainly includes a cylindrical body 30, a core 31, a coil 32, a variable capacity capacitor 33, a circuit board 34, a capacitor 35, and an ink storage portion 36. The cylindrical body 30 has a circular cylindrical shape. The cylindrical body 30 contains in its interior a portion of the core 31, the coil 32, the variable capacity capacitor 33, the circuit board 34, the capacitor 35, and the ink storage portion 36. The core 31 is provided in the tip portion of the electronic pen 3. The core 31 is urged toward the tip of the electronic pen 3 by an elastic member that is not shown in the drawings. The tip portion of the core 31 protrudes to the outside of the cylindrical body 30. The back end of the core 31 is connected to the ink storage portion 36, which stores ink. The ink storage portion 36 supplies the ink to the core 31. When the user uses the electronic pen 3 to write on the form 111, a line drawing may be formed by the ink on the form 111.

The coil 32 is held between the core 31 and the variable capacity capacitor 33 in a state in which the coil 32 is wound around the ink storage portion 36. The variable capacity capacitor 33 is fixed in place in the interior of the electronic pen 3 by the circuit board 34. The capacitor 35 is mounted on the circuit board 34. The capacitor 35 and the variable capacity capacitor 33 are connected in parallel with the coil 32 to configure a known resonance (synchronization) circuit.

The smart phone 19 includes the touch panel 191 and the display 192. The touch panel 191 is used for inputting various types of commands. The display 192 may display the image that corresponds to the image file. A general-purpose personal computer (PC) or a tablet PC may be used instead of the smart phone 19.

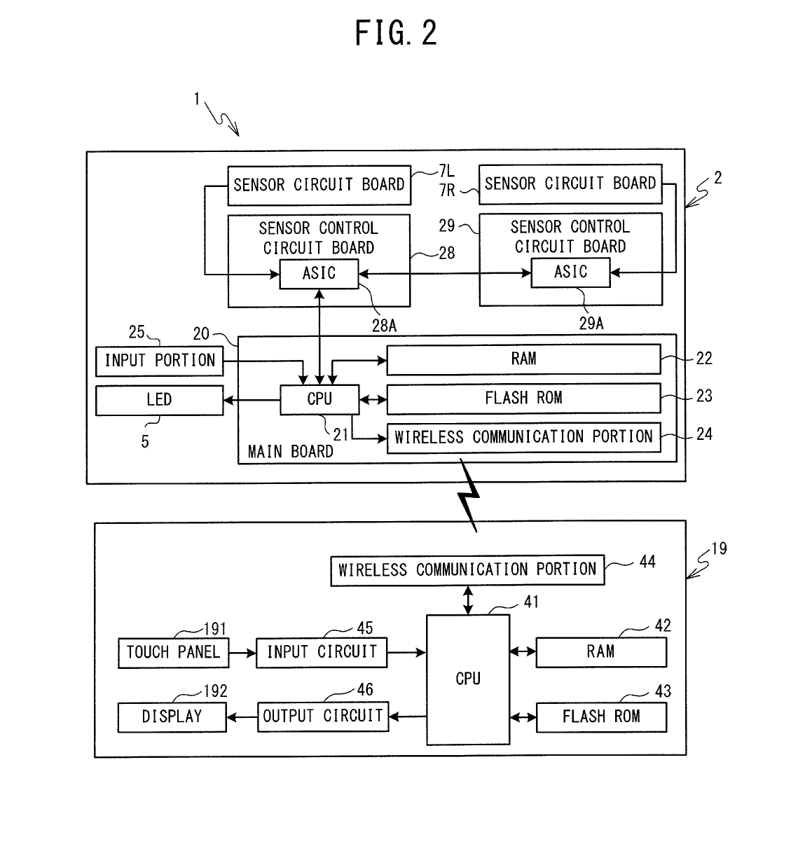

An electrical configuration of the handwriting input system 1 will be explained with reference to FIG. 2. An electrical configuration of the reading device 2 and an overview of the principles by which the reading device 2 detects coordinate data will be explained first. The reading device 2 includes sensor circuit boards 7L, 7R, a main circuit board 20, sensor control circuit boards 28, 29, an input portion 25, and the three LEDs 5. The sensor circuit boards 7L and 7R are provided inside the left reading device 2L and the right reading device 2R, respectively. The input portion 25 and the three LEDs 5 are provided in the right reading device 2R.

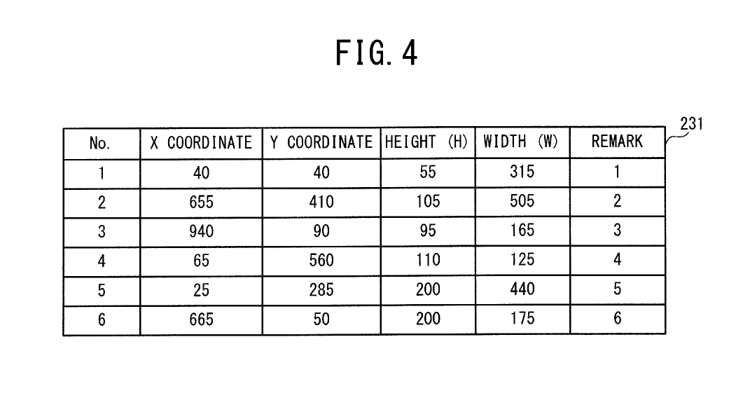

The main board 20 is provided with a CPU 21, a RAM 22, a flash ROM 23, and a wireless communication portion 24. The RAM 22, the flash ROM 23, and the wireless communication portion 24 are electrically connected to the CPU 21. The CPU 21 performs control of the reading device 2. The RAM 22 temporarily stores various data, such as arithmetic operation data. The flash ROM 23 stores programs that are executed by the CPU 21 to control the reading device 2. Further, the flash ROM 23 stores a table 231 (refer to FIG. 4), which will be described below, and a method table. Further, the flash ROM 23 stores layout data for each format of the paper sheet 111. The layout data is information that corresponds to the format. The layout data is data that indicates a writing area of the paper sheet 111 and positions of check boxes. The wireless communication portion 24 is a controller that is used to perform short-range wireless communication with an external electronic device. The input portion 25 and the three LEDs 5 are electrically connected to the CPU 21. The input portion 25 is a switch that is used to input an instruction to the reading device 2. Colors of the three LEDs 5 are yellow, green, and red, respectively.

In each one of the sensor circuit boards 7L and 7R, a plurality of long, thin loop coils are arrayed along both an up-down axis and a left-right axis. The sensor circuit board 7L is electrically connected to an ASIC 28A of the sensor control circuit board 28. In a case where a writing operation is performed by using the electronic pen 3 above the sensor circuit board 7L, the ASIC 28A can detect coordinate data that indicate the position of the electronic pen 3. The sensor circuit board 7R is electrically connected to an ASIC 29A of the sensor control circuit board 29. In a case where a writing operation is performed by using the electronic pen 3 above the sensor circuit board 7R, the ASIC 29A can detect the coordinate data that indicate the position of the electronic pen 3. The ASIC 28A is the master and is connected directly to the CPU 21, while the ASIC 29A is the slave and is connected to the CPU 21 via the ASIC 28A. The front surface of the reading device 2 includes a detection area. The detection area is an area that corresponds to sections of the sensor boards 7L and 7R where the loop coils are disposed. Of the detection area, an area that corresponds to the section of the sensor board 7L where the loop coils are disposed is called a left detection area. Of the detection area, an area that corresponds to the section of the sensor board 7R where the loop coils are disposed is called a right detection area.

The upper left corner of the left detection area of the detection area is defined as an origin O (0, 0). The left-right direction and the up-down direction of the detection area are defined as the X axis direction and the Y axis direction, respectively. The direction from the origin O to the right is defined as the X axis plus direction. The direction downward from the origin O is defined as the Y axis plus direction. Coordinates of the upper right corner of the right detection area are defined as (X2, 0). The coordinate X2 is 1200, for example. Coordinates of the upper right corner of the left detection area are defined as (X3, 0). The coordinate X3 is 600, for example. Coordinates of the lower left corner of the left detection area are defined as (Y2, 0). The coordinate Y2 is 848, for example.

The principles by which the coordinate data are detected in a case where a writing operation is performed by using the electronic pen 3 on the sensor circuit boards 7L, 7R will be explained in general terms. The CPU 21 controls the ASICs 28A and 29A to cause an electric current of a specific frequency (a transmission current for excitation) to flow through each of the loop coils in the corresponding one of the sensor circuit boards 7L and 7R. This causes a magnetic field to be generated by each one of the loop coils in the sensor circuit boards 7L and 7R. In this state, if the user uses the electronic pen 3 to perform an operation of writing a line drawing on the form 111 of the paper medium 100 that is mounted on the reading device 2, for example, the electronic pen 3 may come close to one of the sensor circuit boards 7L and 7R. The resonance circuit of the electronic pen 3 may therefore resonate due to electromagnetic induction and may generate an induced magnetic field.

Next, the CPU 21 controls the ASICs 28A and 29A to stop the generating of the magnetic fields by the individual loop coils in the sensor circuit boards 7L and 7R. Each one of the loop coils in the sensor circuit boards 7L and 7R can receive the induced magnetic field that is generated by the resonance circuit of the electronic pen 3. The CPU 21 controls the ASICs 28A and 29A to detect signal currents (reception currents) that flow through the individual loop coils in the sensor circuit boards 7L and 7R. By performing this operation for each of the loop coils and detecting the reception currents, the ASICs 28A and 29A can detect the coordinate data that describe the position of the electronic pen 3.

When a line drawing is written on the form 111 using the electronic pen 3, a writing pressure is imparted to the core 31. The inductance in the coil 32 varies according to the writing pressure that is imparted to the core 31. This causes the resonance frequency of the resonance circuit of the electronic pen 3 to vary depending on the writing pressure that is imparted to the core 31. The CPU 21 detects the changes (phase changes) in the resonance frequency to specify the writing pressure that is imparted to the electronic pen 3. In other words, the CPU 21 can determine, according to the specified writing pressure, whether a line drawing is being written by using the electronic pen 3 on the form 111 of the paper medium 100.

The method of detecting the position of the electronic pen 3 in the above embodiment can be changed to another method. For example, the reading device 2 may include a touch panel on its top face. In that case, the position where writing is performed by using the electronic pen 3 corresponds to a position where the touch panel is pressed. Therefore, from the touch panel, the CPU 21 of the reading device 2 may acquire coordinate data that indicate the position where the touch panel is pressed.

Next, an electrical configuration of the smart phone 19 will be explained. The smart phone 19 mainly indicates a CPU 41, a RAM 42, a flash ROM 43, a wireless communication portion 44, an input circuit 45, an output circuit 46, the touch panel 191, and the display 192. The CPU 41 performs control of the smart phone 19. The CPU 41 is electrically connected to the RAM 42, the flash ROM 43, the wireless communication portion 44, the input circuit 45, and the output circuit 46.

The RAM 42 stores various types of data temporarily. The wireless communication portion 44 is a controller for performing short-range wireless communication with an external electronic device. The input circuit 45 performs control for sending a command to the CPU 41 from the touch panel 191. The output circuit 46 performs control for displaying an image on the display 192 in response to a command from the CPU 41.

The flash ROM 43 stores programs executed by the CPU 41 and an image file received from the reading device 2. The smart phone 19 is provided with a media reading device (for example, a memory card slot) that is not shown in the drawings. The smart phone 19 can read a program that is stored in a storage medium (for example, a memory card) with the media reading device and can install the program in the flash ROM 43. The smart phone 19 may receive a program from an external device (not shown in the drawings) that is connected to the smart phone 19, or from a network, and then may install the program in the flash ROM 43.

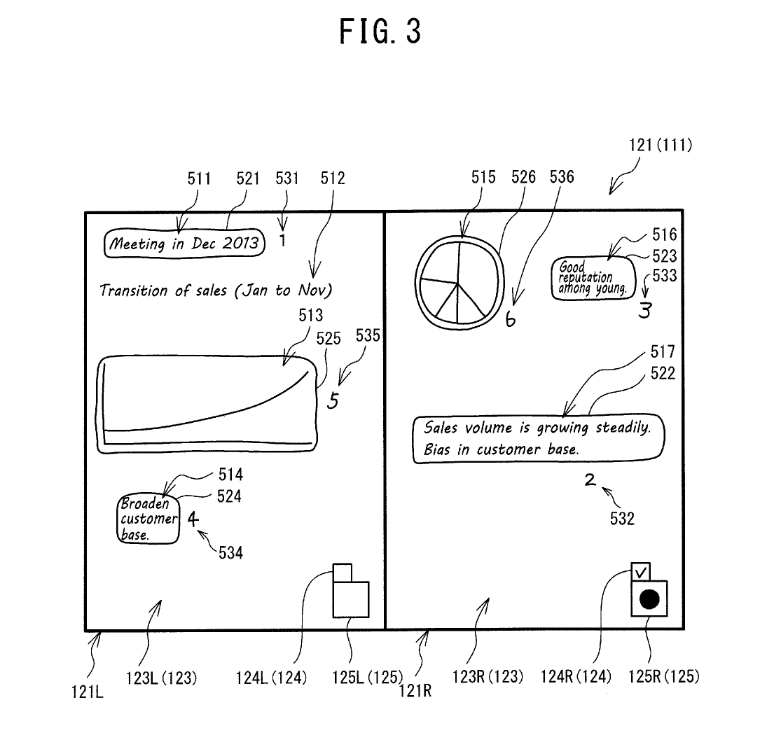

A paper sheet 121, which is an example of the paper sheet 111 of the paper medium 100, will be explained with reference to FIG. 3. In the explanation below, the left side, the right side, the upper side, and the lower side of FIG. 3 are respectively defined as the left side, the right side, the upper side, and the lower side of the paper sheet 111. FIG. 3 shows the paper sheet 121 that corresponds to two pages that are arranged in the left-right direction when the paper medium 100 is in a two-page spread state. In this state, a left page 121L and a right page 121R are arranged side by side in the left-right direction. The left page 121L is a rear surface of the paper sheet 121 that is arranged on the left side. The right page 121R is a front surface of the paper sheet 121 that is arranged on the right side.

As shown in FIG. 3, a writing area 123L, a selection check box 124L, and a save check box 125L are provided on the left page 121L of the paper sheet 121. A writing area 123R, a selection check box 124R, and a save check box 125R are provided on the right page 121R of the paper sheet 121. The save check boxes 125L and 125R are printed at the lower right of the left page 121L and the right page 121R, respectively. Each of the save check boxes 125L and 125R has a rectangular shape. Each of the selection check boxes 124L and 124R has a rectangular shape that is smaller than the save check boxes 125L and 125R. The selection check boxes 124L and 124R are respectively arranged to be adjacent to the upper left of the save check boxes 125L and 125R. Hereinafter, when the writing areas 123L and 123R are collectively referred to, they are referred to as a writing area or writing areas 123. When the selection check boxes 124L and 124R are collectively referred to, they are referred to as a selection check box 124. When the save check boxes 125L and 125R are collectively referred to, they are referred to as a save check box 125.

The writing area 123 is an area for the user to write line drawings. The selection check box 124 is an area in which the user writes a line drawing in order to end an operation in a normal mode and to switch to a selection mode. The save check box 125 is an area in which the user writes a line drawing in order to confirm the line drawing written in the writing area 123, in a state in which the reading device 2 is operating in the normal mode. Further, there is also a case in which a specifying mark, which will be described below, is written in the save check box 125 in a state in which the reading device 2 is operating in the selection mode. Details will be described below.

The paper sheet 111 that can be used in the reading device 2 is not limited to the paper sheet 121 shown in FIG. 3, and may be the paper sheet 111 in another format. The shape and the position of each of the selection check box 124 and the save check box 125 can be changed. For example, each of the selection check box 124 and the save check box 125 may have a circular shape. The selection check box 124 and the save check box 125 may be provided at one of the upper left, the lower left, and the upper right of the writing area 123. The selection check box 124 and the save check box 125 may be separated from each other. For example, the selection check box 124 may be provided at the lower left of each of the writing areas 123, and the save check box 125 may be provided at the lower right of each of the writing areas 123.

An overview of processing in which the CPU 21 creates an image file based on a line drawing written on the paper sheet 121 will be explained with reference to FIG. 3. When a power source of the reading device 2 is turned on, the CPU 21 sets the operation mode of the reading device 2 to the normal mode. While a writing pressure is being applied to the electronic pen 3, the CPU 21 of the reading device 2 repeatedly acquires coordinate data that indicates a position of the electronic pen 3 at a predetermined interval, via the ASICs 28A and 29A,. The CPU 21 associates each of the acquired plurality of sets of coordinate data with time data that indicates a time at which the coordinate data set is acquired, and stores the associated data in a first storage area of the RAM 22. The plurality of sets of coordinate data and the plurality of sets of time data that are stored in the first storage portion at a point in time at which the application of the writing pressure to the electronic pen 3 ends indicate a position of a single line that forms the line drawing written on the paper sheet 121 using the electronic pen 3. Hereinafter, when the plurality of sets of coordinate data that indicate the position of the single line and the plurality of sets of time data associated with the respective plurality of sets of coordinate data are correctively referred to, they are referred to as line data.

When it is determined that the application of the writing pressure to the electronic pen 3 has ended, the CPU 21 determines whether a line drawing has been written in one of the writing area 123, the selection check box 124, and the save check box 125 of the paper sheet 121, based on the line data stored in the first storage area of the RAM 22. When it is determined that a line drawing has been written in the writing area 123, the CPU 21 stores, in a second storage area of the RAM 22, the line data stored in the first storage area. Then, the CPU 21 clears the first storage area. Every time the user may write a line one by one in the writing area 123 using the electric pen 3, the line data is sequentially stored in the second storage area. In other words, the line data of the line drawings that are written in the writing area 123 during an operation in the normal mode are accumulated in the second storage area.

After the line drawing is written in the writing area 123, when it is determined that a line drawing is written in the save check box 125, the CPU 21 creates stroke data that includes at least one set of line data stored in the second storage area of the RAM 22. The stroke data includes at least one set of line data that is acquired from when the line drawing is written in the save check box 125 to when a line drawing is next written in the save check box 125. Next, the CPU 21 extracts the at least one set of line data included in the created stroke data, one at a time. Using straight lines, the CPU 21 connects a plurality of positions indicated by the plurality of sets of coordinate data that correspond to the extracted line data, in order of times that are indicated by the associated plurality of sets of time data. The CPU 21 combines the lines that are obtained one at a time for each line data set, and identifies the combined lines as a line drawing. The CPU 21 creates an image file of an image that includes the identified line drawing. The image file is a data file that shows the line drawing as a digital image. In this manner, when the reading device 2 operates in the normal mode, the save check box 125 is used to confirm the line drawing written in the writing area 123 and to instruct the creation of the image file that includes the confirmed line drawing.

An explanation will be given using a specific example. Referring to FIG. 3, a case will be described as an example in which, after line drawings 511 to 514 are written in the writing area 123L, a check mark is written in the save check box 125R. The line drawing 511 shows the character string “Meeting in December 2013.” The line drawing 512 shows the character string “Transition of sales (Jan to Nov).” The line drawing 513 shows a line graph. The line drawing 514 shows the character string “Broaden customer base.” In this case, the CPU 21 creates the stroke data that indicates the line drawings 511 to 514. Next, based on the created stroke data, the CPU 21 creates an image file that shows the line drawings 511 to 514. Next, a case will be described as an example in which after line drawings 515 to 517 are written in the writing area 123R, a check mark is written in the save check box 125R. The line drawing 515 shows a pie chart. The line drawing 516 shows the character string “Good reputation among young.” The line drawing 517 shows the character string “Sales volume is growing steadily. Bias in customer base.” In this case, the CPU 21 creates the stroke data that indicates the line drawings 515 to 517. Next, based on the created stroke data, the CPU 21 creates an image file that shows the line drawings 515 to 517.

The CPU 21 may create an image file that only shows the line drawings written in the writing area 123L when a check mark is written in the save check box 125L, and may create an image file that only shows the line drawings written in the writing area 123R when a check mark is written in the save check box 125R. In other words, when a check mark is written in one of the save check boxes 125L and 125R, the CPU 21 may create an image file that only shows the line drawings written in the corresponding one of the writing areas 123L and 123R.

On the other hand, when it is determined that a line drawing has been written in the selection check box 124 after the line drawings have been written in the writing area 123, first, the CPU 21 deletes the line data corresponding to the line drawing written in the selection check box 124, from the first storage area of the RAM 22. The CPU 21 operates in the selection mode during a period from when the line drawing is written in the selection check box 124 to when a line drawing is written in the save check box 125. When a line drawing is written in the writing area 123 during the operation in the selection mode, the CPU 21 stores, in a third storage area of the RAM 22, the line data stored in the first storage area of the RAM 22, and clears the first storage area. In other words, the line data of the line drawings that are written in the writing area 123 during the operation in the selection mode are accumulated in the third storage area. The CPU 21 identifies the line drawings based on the line data stored in the third storage area. Then, the CPU 21 identifies a plurality of areas that are selected by the identified line drawings, and a plurality of numbers that are shown by the line drawings. In this manner, the selection check box 124 is used to end the operation of the reading device 2 in the normal mode and to switch to the selection mode.

An explanation will be given using a specific example. Referring to FIG. 3, a case will be described as an example in which after the line drawings 511 to 517 are written in the writing area 123, a check mark is written in the selection check box 124R, and then line drawings 521 and 531 are written in the writing area 123 such that the line drawings 521 and 531 are close to each other. The line drawing 521 is a line drawing that surrounds an area which is within the writing area 123 and in which the line drawing 511 has been written. The line drawing 531 shows the number “1.” Hereinafter, the line drawing that surrounds a particular area is referred to as a surrounding line drawing. Hereinafter, the line drawing that shows a number is referred to as a number line drawing. In this case, the CPU 21 reads the line data corresponding to each of the line drawings 521 and 531 from the third storage area of the RAM 22. Based on the line data that corresponds to the line drawing 521, the CPU 21 identifies a smallest rectangle that includes the area surrounded by the line drawing 521. Specifically, this is performed as follows. The CPU 21 identifies four coordinates, i.e., a minimum X coordinate, a maximum X coordinate, a minimum Y coordinate, and a maximum Y coordinate, based on the plurality of coordinate data included in the line data that corresponds to the line drawing 521. The CPU 21 identifies a rectangle whose vertices correspond to the identified four coordinates, as the smallest rectangle that includes the area surrounded by the line drawing 521. Hereinafter, the area surrounded by the identified rectangle is referred to as a selected area. Further, the CPU 21 identifies the number shown by the line drawing 531, based on the read line data.

Next, the CPU 21 stores data relating to the identified selected area and number in the table 231 shown in FIG. 4. The table 231 will be explained with reference to FIG. 4. The coordinate data indicating the X coordinate and the Y coordinate of the upper left position of the rectangle that shows the selected area is stored in the table 231. Further, data that indicates the length in the up-down direction of the selected area is stored in the table 231, as a height (H). Further, data that indicates the length in the left-right direction of the selected area is stored in the table 231, as a width (W). Further, data that indicates the identified number is stored in the table 231, as a remark. Further, an index that indicates the order of writing of the surrounding line drawings is stored in the table 231 in association with the data of the X coordinate, the Y coordinate, the height (H), the width (W) and the remark. Hereinafter, an aggregation of the index, the X coordinate, the Y coordinate, the height (H), the width (W), and the remark, which is stored in the table 231, is referred to as a record.

An explanation will be given using a specific example. A case will be described as an example in which, when the reading device 2 is operating in the selection mode, the line drawings 521 to 526 (refer to FIG. 3), which are surrounding line drawings, are sequentially written and then the line drawings 531 to 536 (refer to FIG. 3), which are number line drawings, are respectively written in positions that are close to the line drawings 521 to 526. The line drawings 521, 522, 523, 524, 525, and 526 respectively surround areas which are within the writing area 123 and in which the line drawings 511, 517, 516, 514, 513, and 515 are respectively written. Every time each of the line drawings 521 to 526 is written, the CPU 21 identifies the selected area based on the line data of the surrounding line drawing that has been written. The CPU 21 associates the data (the X coordinate, the Y coordinate, the height (H), and the width (W)) relating to the identified selected area with the index, and stores the associated data in the table 231. Further, when it is determined that each of the line drawings 531 to 536 has been written, the CPU 21 associates each of the written line drawings 531 to 536 with the surrounding line drawing that is closest to each of the line drawings 531 to 536. The CPU 21 associates the data (the X coordinate, the Y coordinate, the height (H), and the width (W)) relating to the selected area that corresponds to each of the line drawings 521 to 526 with the number identified by each of the line drawings 531 to 536, as a remark, and stores the associated data in the table 231.

Next, when it is determined that a line drawing has been written in the save check box 125 during the operation in the selection mode, the CPU 21 determines whether the line drawing written in the save check box 125 is one of a first circle mark, a second circle mark, a first triangle mark, a second triangle mark, a first square mark, and a second square mark. Hereinafter, when the first circle mark, the second circle mark, the first triangle mark, the second triangle mark, the first square mark, and the second square mark are collectively referred to, they are referred to as a specifying mark or specifying marks. The specifying mark is a mark to specify an ordering method and an arrangement method of the plurality of selected areas that are identified based on the plurality of surrounding line drawings. The first circle mark, the first triangle mark, and the first square mark are a black circle, a black triangle, and a black square, respectively. The second circle mark, the second triangle mark, and the second square mark are a white circle, a white triangle, and a white square, respectively.

The first circle mark and the second circle mark are marks that are used to specify that the plurality of selected areas corresponding to the plurality of surrounding line drawings are ordered in the order in which the plurality of surrounding line drawings are written. The first triangle mark and the second triangle mark are marks that are used to specify that the plurality of selected areas corresponding to the plurality of surrounding line drawings are ordered in the order of the numbers that are identified by the number line drawings respectively written close to the plurality of surrounding line drawings. The first square mark and the second square mark are marks that are used to specify that the plurality of selected areas are ordered in the following manner. First, the plurality of selected areas on the left page 121L are arranged from the top to the bottom, in ascending order of the minimum Y coordinate values of the respective selected areas. Next, the plurality of selected areas on the right page 121R are arranged from the top to the bottom, in ascending order of the minimum Y coordinate values of the respective selected areas. Further, the first circle mark, the first triangle mark, and the first square mark are marks that are used to specify that the plurality of selected areas are sequentially arranged downward from the upper left. The second circle mark, the second triangle mark, and the second square mark are marks that are used to specify that the plurality of selected areas are ordered in the following manner. First, the plurality of selected areas are sequentially arranged from the upper left to the right. When there is no space in the rightward direction, the selected areas are aligned to the left, below the already arranged selected areas. In this manner, when the reading device 2 is operating in the selection mode, the save check box 125 is used to specify the ordering method and the arrangement method of the selected areas.

When it is determined that the specifying mark has been written in the save check box 125 during the operation in the selection mode, the CPU 21 determines the ordering method and the arrangement method that correspond to the specifying mark, based on the method table that is not shown in the drawings. The method table is stored in the flash ROM 23. A plurality of pieces of type information are stored in the method table. The type information indicates a type of the specifying mark. Further, an ordering method and a plurality of arrangement methods that are respectively associated with the plurality of pieces of type information are stored in the method table. The CPU 21 identifies a type of the specifying mark based on the shape of the written line drawing. The CPU 21 can determine the ordering method and the arrangement method that are associated with the type information of the identified type, by referring to the method table.

When the specifying mark is written in the save check box 125, the CPU 21 identifies the plurality of selected areas based on the table 231 (refer to FIG. 4). Then, the CPU 21 extracts the line data stored in the second storage area of the RAM 22, for each of the plurality of selected areas. The CPU 21 identifies the line drawing that is included in each of the selected areas, based on the line data extracted for each of the selected areas. Hereinafter, the line drawing that is included in the selected area is referred to as a selected line drawing. The CPU 21 creates the stroke data that indicates each of the selected line drawings. The CPU 21 arranges the plurality of selected areas and the plurality of selected line drawings that respectively correspond to the plurality of selected areas, using the ordering method and the arrangement method determined corresponding to the type of the specifying mark. After that, the CPU 21 converts the stroke data indicating the plurality of selected line drawings, in accordance with changes of the positions of the plurality of selected line drawings. Based on the converted stroke data, the CPU 21 creates an image file in which the selected line drawings are each arranged using the ordering method and the arrangement method that correspond to the type of the specifying mark.

An explanation will be given using a specific example. In the specific example, as shown in FIG. 3, the line drawings 511 to 517 are written in the normal mode. Next, the line drawings 521 to 526, which are the surrounding line drawings, and the line drawings 531 to 536, which are the number line drawings, are written in the selection mode. After that, the first circle mark is written in the save check box 125R.

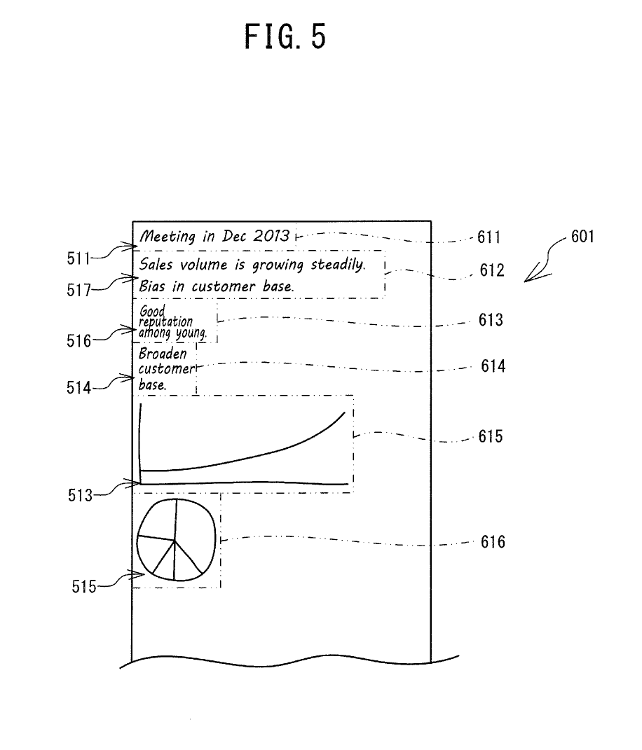

The CPU 21 identifies selected areas 611 to 616 (refer to FIG. 5) based on the line drawings 521 to 526. The CPU 21 stores records that respectively correspond to the identified selected areas 611 to 616, in the table 231 (refer to FIG. 4). Based on the records stored in the table 231, the CPU 21 extracts the line data for each of the identified selected areas 611 to 616, from the second storage area of the RAM 22. Based on the line data extracted for each of the selected areas 611 to 616, the CPU 21 creates the stroke data that indicates each of the selected line drawings (the line drawings 511, 517, 516, 514, 513, and 515). The first circle mark has been written in the save check box 125. Therefore, the CPU 21 sequentially arranges the selected areas 611 to 616 downward from the upper left, in the order in which the corresponding line drawings 521 to 526 have been written. The CPU 21 converts the stroke data such that the line drawings 511, 517, 516, 514, 513, and 515 are arranged using this ordering method and this arrangement method. The CPU 21 creates an image file based on the converted stroke data.

An image 601 that is shown by the created image file will be explained with reference to FIG. 5. The left side, the right side, the upper side, and the lower side of FIG. 5 are respectively defined as the left side, the right side, the upper side, and the lower side of the image 601. The CPU 21 causes one set of the coordinates that are indicated by the coordinate data detected by the sensor boards 7L and 7R to correspond to one pixel of the image 601. The CPU 21 causes the X axis plus direction of the reading device 2 to correspond to the direction from the left to the right of the image 601. The CPU 21 causes the Y axis plus direction of the reading device 2 to correspond to the direction from the top to the bottom of the image 601. A total number of pixels in the left-right direction of the image 601 is set to X3 that is the same as the X coordinate of the upper right corner of the left detection area of the reading device 2. The number of pixels in the up-down direction of the image 601 is not limited.

The CPU 21 sequentially arranges the selected areas 611 to 616 downward from the top such that the left edges of the selected areas 611 to 616 are aligned with the left edge of the image 601. The upper left corner of the selected area 611 is arranged at the upper left corner of the image 601. The upper left corner of the selected area 612 is arranged at the lower left corner of the selected area 611. The upper left corner of the selected area 613 is arranged at the lower left corner of the selected area 612. The upper left corner of the selected area 614 is arranged at the lower left corner of the selected area 613. The upper left corner of the selected area 615 is arranged at the lower left corner of the selected area 614. The upper left corner of the selected area 616 is arranged at the lower left corner of the selected area 615. The line drawings 511, 517, 516, 514, 513, and 515 are respectively arranged in the corresponding selected areas 611 to 616.

A case will be described as an example in which the first triangle mark is written in the save check box 125R, differently from the case shown in FIG. 3. In the example shown in FIG. 3, the line drawings 531 to 536 are the number line drawings that are respectively close to the line drawings 521 to 526, which are the surrounding line drawings. The line drawings 531 to 536 show the numbers “1” to “6,” respectively. In this example, it is assumed that the numbers “1” to “6” accord with the order in which each of the line drawings 521 to 526 is written. Therefore, when the first triangle mark is written in the save check box 125, the CPU 21 creates an image file of the same image 601 as that in FIG. 5.

A case will be described as an example in which the first square mark is written in the save check box 125R, differently from the case shown in FIG. 3. In the example shown in FIG. 3, the line drawings 521, 525, and 524, which are the surrounding line drawings, are arranged in that order from the top to the bottom on the left page 121L. The line drawings 526, 523, and 522 are arranged in that order from the top to the bottom on the right page 121R. Further, the respective line drawings 511, 513, 514, 515, 516, and 517 are selected, as the selected line drawings, by the selected areas that are identified based on the respective line drawings 521, 525, 524, 526, 523, and 522. In this case, using the same method as that described above, the CPU 21 creates the stroke data that indicates each of the selected line drawings (the line drawings 511, 513, 514, 515, 516, and 517). Based on the fact that the line drawings 521, 525, 524, 526, 523, and 522 are arranged in that order, the CPU 21 sequentially arranges the selected areas that respectively correspond to these line drawings, downward from the upper left. The CPU 21 converts the stroke data such that the line drawings 511, 513, 514, 515, 516, and 517 are arranged in the order and the arrangement that are the same as those of the corresponding selected areas. The CPU 21 creates an image file based on the converted stroke data. In this case, although not shown in the drawings, the image file of an image is created in which the line drawings 511 and 513 to 517 are sequentially arranged downward from the upper left.

A case will be described as an example in which the second circle mark is written in the save check box 125R, differently from the case shown in FIG. 3. In this case, when the next selected area is arranged to the right of a particular selected area, the CPU 21 determines whether or not the length in the left-right direction of the two selected areas is equal to or less than X3 (=600). When the CPU 21 determines that the length in the left-right direction is equal to or less than X3, the CPU 21 arranges the next selected area to the right of the particular selected area such that the two selected areas are arranged side by side. On the other hand, when the CPU 21 determines that the length in the left-right direction is larger than X3, the CPU 21 arranges the next selected area below the particular selected area such that the next selected area is aligned to the left. Thus, the CPU 21 inhibits the selected areas from running off the right edge of the image that is shown by the image file to be created.

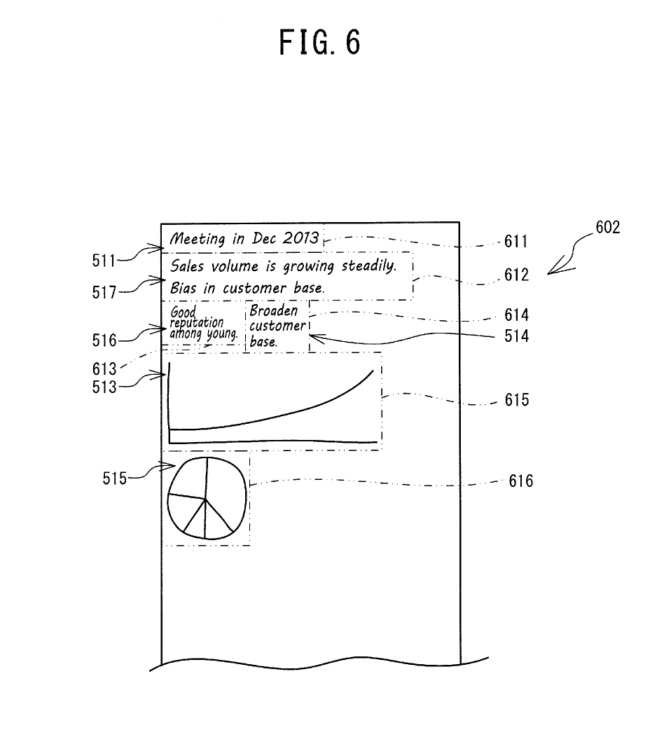

Using the same method as that described above, the CPU 21 creates the stroke data that indicates each of the selected line drawings (the line drawings 511, 517, 516, 514, 513, and 515) that correspond to the plurality of selected areas 611 to 616 (refer to FIG. 6). The CPU 21 converts the stroke data such that the plurality of selected areas 611 to 616 and the selected line drawings (the line drawings 511, 517, 516, 514, 513, and 515) are arranged using the above-described ordering method and arrangement method. The CPU 21 creates an image file based on the converted stroke data.

An image 602 that is shown by the created image file will be explained with reference to FIG. 6. The left side, the right side, the upper side, and the lower side of FIG. 6 are respectively defined as the left side, the right side, the upper side, and the lower side of the image 602. The CPU 21 sequentially arranges the selected areas 611 to 613, 615, and 616 downward from the top such that the left edges of the selected areas 611 to 613, 615, and 616 are aligned with the left edge of the image 602. The line drawings 511, 517, 516, 513, and 515 are respectively arranged in the corresponding selected areas 611 to 613, 615, and 616. Differently from the image 601, in the image 602, the selected area 614 is arranged to the right of the selected area 613, and the line drawing 514 is arranged in the selected area 614. The upper left corner of the selected area 616 is arranged at the upper right corner of the selected area 613. When the selected area 614 is arranged to the right of the selected area 613, the length in the left-right direction of the selected areas 613 and 614 is equal to or less than X3 (=600). Therefore, the CPU 21 arranges the selected area 614 in this manner.

When the second triangle mark is written in the save check box 125R, the CPU 21 creates an image file of the same image 602 as that in FIG. 6. The explanation of a specific example in which the second square mark is written in the save check box 125R is omitted.

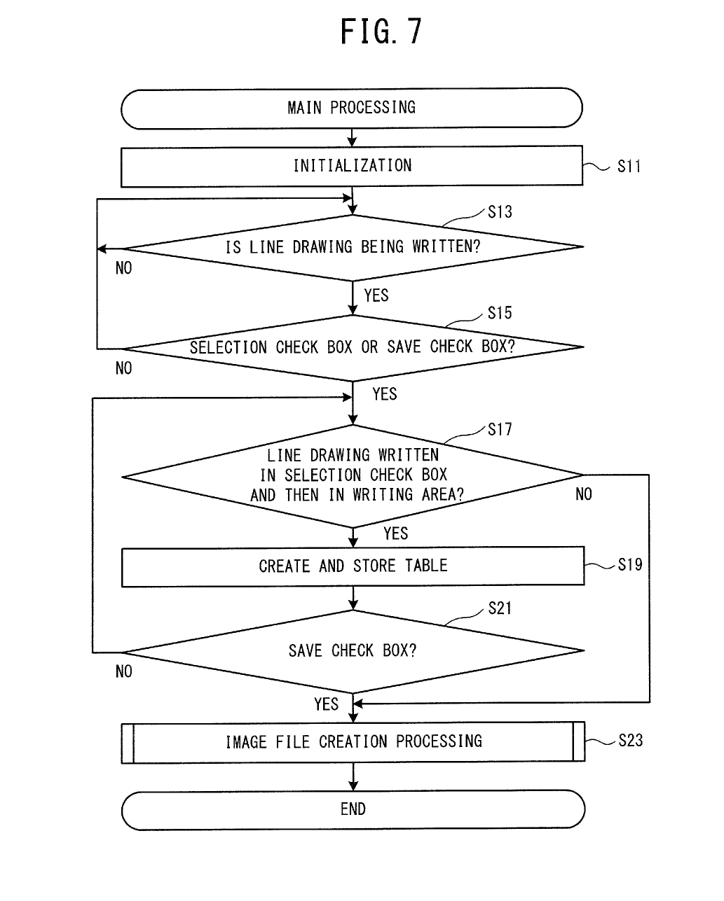

Main processing that is performed by the CPU 21 of the reading device 2 will be explained with reference to FIG. 7 to FIG. 10. First, the user may position and mount the paper medium 100 on the front surface of the reading device 2. The user may open the paper medium 100 to a two-page spread such that the left page 121L and the right page 121R of the paper sheet 121 (refer to FIG. 3) are arranged on the left and the right, respectively. In this state, the user may turn on the power source of the reading device 2. When the power source of the reading device 2 is turned on, the CPU 21 operates based on the program stored in the flash ROM 23 and thus starts the main processing.

The CPU 21 performs initialization (step S11). In the initialization, the CPU 21 clears the data stored in the RAM 22. The CPU 21 starts control of the ASICs 28A and 29A. In this state, the CPU 21 can determine whether or not a line drawing is being written using the electronic pen 3 on the paper sheet 121 of the paper medium 100 mounted on the reading device 2. When it is determined that a line drawing is being written using the electronic pen 3, the CPU 21 can acquire the coordinate data that indicates a position of the electronic pen 3.

In the initialization, the CPU 21 reads, from the flash ROM 23, the layout data of the format of the paper sheet 121 of the paper medium 100 mounted on the reading device 2, and stores the read layout data in the RAM 22. Based on the layout data, the CPU 21 identifies areas of the front surface of the reading device 2 that respectively correspond to the selection check box 124 and the save check box 125 (refer to FIG. 3). The CPU 21 identifies an area of the front surface of the reading device 2, excluding the areas that correspond to the selection check box 124 and the save check box 125, as an area corresponding to the writing area 123. Hereinafter, the area of the front surface of the reading device 2 that corresponds to the selection check box 124 is referred to as a selection check area. The area of the front surface of the reading device 2 that corresponds to the save check box 125 is referred to as a save check area.

After performing the initialization processing, the CPU 21 switches the operation mode to the normal mode. Based on the writing pressure applied to the electronic pen 3, the CPU 21 determines whether or not a line drawing is being written on the paper sheet 121 (step S13). When it is determined that a line drawing is not being written on the paper sheet 121 (no at step S13), the CPU 21 returns the processing to step S13 and repeats the processing at step S13. When it is determined that a line drawing is being written on the paper sheet 121 (yes at step S13), the CPU 21 acquires the coordinate data that indicates a position of the electronic pen 3 detected via the ASICs 28A and 29A. More specifically, while the writing pressure is being applied to the electronic pen 3, the CPU 21 repeatedly acquires the coordinate data at a certain interval via the ASICs 28A and 29A. When the coordinate data is acquired, the CPU 21 acquires time data that indicates a time at which the coordinate data is acquired. The CPU 21 associates the acquired coordinate data with the acquired time data and stores the associated data in the first storage area of the RAM 22. Until the writing of one line using the electronic pen 3 is completed, the CPU 21 repeats the processing that stores the coordinate data and the time data in the first storage area. When the writing of the one line using the electronic pen 3 is completed, the line data corresponding to at least one line is stored in the first storage area.

When it is determined that the writing of the one line is completed, the CPU 21 determines whether or not a line drawing has been written in the selection check box 124 or the save check box 125 (step S15). More specifically, when none of the plurality of positions that are indicated by the coordinate data included in the line data stored in the first storage area of the RAM 22 are positions in the selection check area or the save check area, the CPU 21 determines that the line drawing is not written in either the selection check box 214 or the save check box 125 (no at step S15). In this case, the line drawing is written in the writing area 123. Hereinafter, the plurality of positions indicated by the coordinate data included in the line data are referred to as a plurality of positions indicated by the line data. The CPU 21 stores the line data stored in the first storage area, in the second storage area of the RAM 22. Then, the CPU 21 clears the first storage area. The CPU 21 returns the processing to step S13.

For example, as shown in FIG. 3, when the line drawing 511 is written in the writing area 123L, the CPU 21 stores the line data corresponding to the line drawing 511 in the second storage area of the RAM 22, and clears the first storage area of the RAM 22. Then, when the line drawing 512 is written in the writing area 123L, the CPU 21 stores the line data corresponding to the line drawing 512 in the second storage area, and clears the first storage area. Similar processing is repeated every time each of the line drawings 513 to 517 is written. As a result, the plurality of sets of line data that indicate the line drawings 511 to 517 written in the writing area 123 are stored in the second storage area.

When at least one of the plurality of positions indicated by the line data is a position in the selection check area or the save check area, the CPU 21 determines that a line drawing has been written in one of the selection check box 124 and the save check box 125 (yes at step S15). The CPU 21 determines whether or not the line drawing has been written in the selection check box 124 and then a line drawing has been written in the writing area 123 (step S17). When it is determined that the line drawing has not been written in the selection check box 124, the line drawing has been written in the save check box 125. When it is determined that the line drawing has not been written in the selection check box 124 (no at step S17), the CPU 21 advances the processing to step S23.

When it is determined that the line drawing has been written in the selection check box 124, the CPU 21 changes the operation mode from the normal mode to the selection mode. The CPU 21 clears the first storage area of the RAM 22. When it is determined that the writing of the line drawing is started, the CPU 21 repeats the processing that stores the line data in the first storage area until a predetermined time period has elapsed without the line drawing being written. The reason why this processing is repeated is that, when numbers are shown by a plurality of line drawings, it is necessary to collect up the line data indicating each of the plurality of line drawings. When it is determined that the predetermined time period has elapsed without the line drawing being written, the CPU 21 determines whether or not a line drawing is written in the writing area 123 based on the line data stored in the first storage area. After the line drawing has been written in the selection check box 124, when it is determined that a line drawing has been written in the save check box 125 without a line drawing being written in the writing area 123 (no at step S17), the CPU 21 changes the operation mode from the selection mode to the normal mode, and advances the processing to step S23.

After the line drawing has been written in the selection check box 124, when it is determined that a line drawing has been written in the writing area 123 (yes at step S17), the CPU 21 stores, in the third storage area of the RAM 22, the line data stored in the first storage area of the RAM 22. The CPU 21 clears the first storage area. Based on the line data stored in the third storage area, the CPU 21 classifies each of the line drawings identified by the line data into one of the surrounding line drawing (for example, the line drawings 521 to 526, refer to FIG. 3) and the number line drawing (for example, the line drawings 531 to 536, refer to FIG. 3).

A specific method for classifying each of the line drawings into one of the surrounding line drawing and the number line drawing is as follows. Using a known pattern matching technique, the CPU 21 determines whether or not the line drawing that is identified based on the line data stored in the third storage area of the RAM 22 is the surrounding line drawing. A database for pattern matching of the surrounding line drawings is stored in the flash ROM 23. The database includes data of reference patterns (for example, a circle, an ellipse, a rectangle, and the like) that show the surrounding line drawings. Based on the line data and the reference pattern data, the CPU 21 compares the line drawing identified by the line data with the reference patterns. When it is determined that one of the reference patterns that indicate the surrounding line drawings is similar to the line drawing, the CPU 21 determines that the line drawing is the surrounding line drawing.

Using a known character recognition technique, the CPU 21 determines whether or not the line drawing that is identified based on the line data stored in the third storage area of the RAM 22 is the number line drawing. A database for character recognition is stored in the flash ROM 23. The database includes at least data of reference patterns that show the numbers “0” to “9.” Based on the line data and the reference pattern data, the CPU 21 compares the line drawing identified by the line data with the reference patterns. When it is determined that one of the reference patterns that indicate the numbers is similar to the line drawing, the CPU 21 determines that the line drawing is the number line drawing, and identifies the number that corresponds to the surrounding line drawing. Hereinafter, the line data corresponding to the surrounding line drawing is referred to as surrounding line data. The line data corresponding to the number line drawing is referred to as number line data.

After classifying the line data stored in the third storage area of the RAM 22, the CPU 21 creates the table 231 (refer to FIG. 4) (step S19). Details are as follows. When the line data stored in the third storage area is classified as the surrounding line data, the CPU 21 identifies the selected area using the above-described method, based on the surrounding line data. The CPU 21 stores, in the table 231, the data (the index, the X coordinate, the Y coordinate, the height (H), and the width (W), refer to FIG. 4) relating to the identified selected area. On the other hand, when the line data stored in the third storage area is classified as the number line data, the CPU 21 selects, from the table 231, the data relating to the selected area that is closest to the position indicated by the number line data. The CPU 21 associates the selected data with the number identified based on the number line data, as a remark, and stores the associated data in the table 231. After storing the data in the table 231, the CPU 21 advances the processing to step S21.

For example, in the example shown in FIG. 3, the line drawings 531 to 536, which are the number line drawings, are written in the vicinity of the respective line drawings 521 to 526, which are the surrounding line drawings. Therefore, the CPU 21 associates, as remarks, the numbers “1” to “6” identified based on the respective line drawings 531 to 536 with the data relating to the selected areas that correspond to the respective line drawings 521 to 526, and stores the associated data in the table 231.

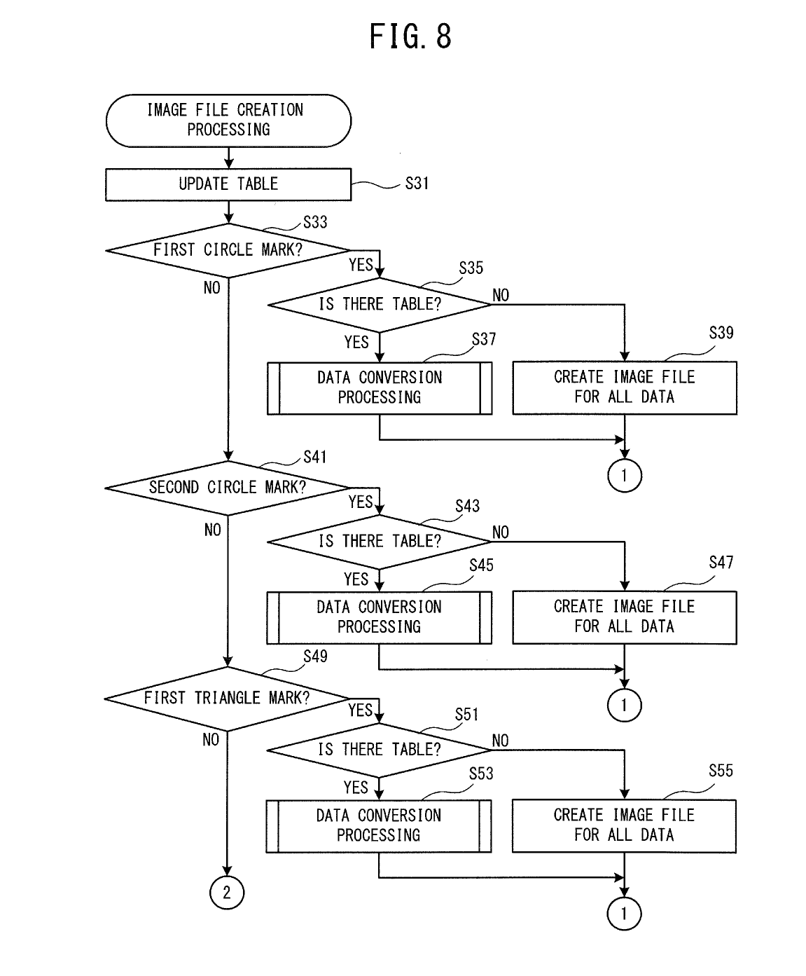

The CPU 21 determines whether or not the line drawing has been written in the save check box 125 during the operation in the selection mode, based on the line data stored in the first storage area of the RAM 22 (step S21). When it is determined that the line drawing has not been written in the save check box 125 (no at step S21), the CPU 21 returns the processing to step S17. As the line drawing has already been written in the selection check box 124, when it is determined that the line drawing has been written in the writing area 123 (yes at step S17), the CPU 21 repeats the processing that creates the table 231 (step S19). On the other hand, when it is determined that the line drawing has been written in the save check box 125 during the operation in the selection mode (yes at step S21), the CPU 21 switches the operation mode from the selection mode to the normal mode. The CPU 21 performs image file creation processing (refer to FIG. 8) (step S23). The image file creation processing will be described in detail below. After the image file creation processing is completed, the CPU 21 ends the main processing.

The image file creation processing will be explained with reference to FIG. 8. Based on the line data stored in the first storage area of the RAM 22, the CPU 21 determines which of the six specifying marks matches the line drawing written in the save check box 125. More specifically, using the known pattern matching technique, the CPU 21 identifies the specifying mark that matches the line drawing identified based on the line data stored in the first storage area. A database for pattern matching of the specifying marks is stored in the flash ROM 23. The data of the reference patterns that show the specifying marks is stored in the database. Based on the line data and the reference pattern data, the CPU 21 compares the line drawing identified by the line data with the reference patterns. When it is determined that one of the reference patterns that indicate the specifying marks is similar to the line drawing, the CPU 21 determines that the line drawing matches the specifying mark that is indicated by the reference pattern. The CPU 21 refers to the method table and determines the ordering method and the arrangement method that correspond to the specifying mark that has been determined to match the line drawing. On the other hand, when it is determined that a line drawing that is other than the six specifying marks has been written in the save check box 125, the CPU 21 does not determine the ordering method and the arrangement method.

In a case where the table 231 (refer to FIG. 4) is created at step S19 (refer to FIG. 7) and stored in the flash ROM 23, the CPU 21 arranges the records of the table 231 from the top to the bottom using the determined ordering method (step S31). Details are as follows. When it is determined that the specifying mark written in the save check box 125 is one of the first circle mark and the second circle mark, the CPU 21 arranges the records from the top to the bottom in the order of the index values. By doing this, the plurality of selected areas that correspond to the plurality of surrounding line drawings are ordered in the order in which the plurality of surrounding line drawings are written by the user. When it is determined that the specifying mark written in the save check box 125 is one of the first triangle mark and the second triangle mark, the CPU 21 arranges the records from the top to the bottom in the order of the values of the remarks. By doing this, the plurality of selected areas are ordered in the order of the numbers identified by the number line drawings. When it is determined that the specifying mark written in the save check box 125 is one of the first square mark and the second square mark, the CPU 21 refers to the table 231 and arranges the records whose X coordinates are equal to or smaller than X3 (=600), in ascending order of the Y coordinates. After that, the CPU 21 arranges the records whose X coordinates are larger than X3, in ascending order of the Y coordinates. When there are a plurality of data having the same Y coordinate, the record with a smaller X coordinate is given priority. Thus, the plurality of selected areas that correspond to the surrounding line drawings written in the writing area 123L are sequentially ordered from the upper left. After that, the plurality of selected areas that correspond to the surrounding line drawings written in the writing area 123R are sequentially ordered from the upper left.

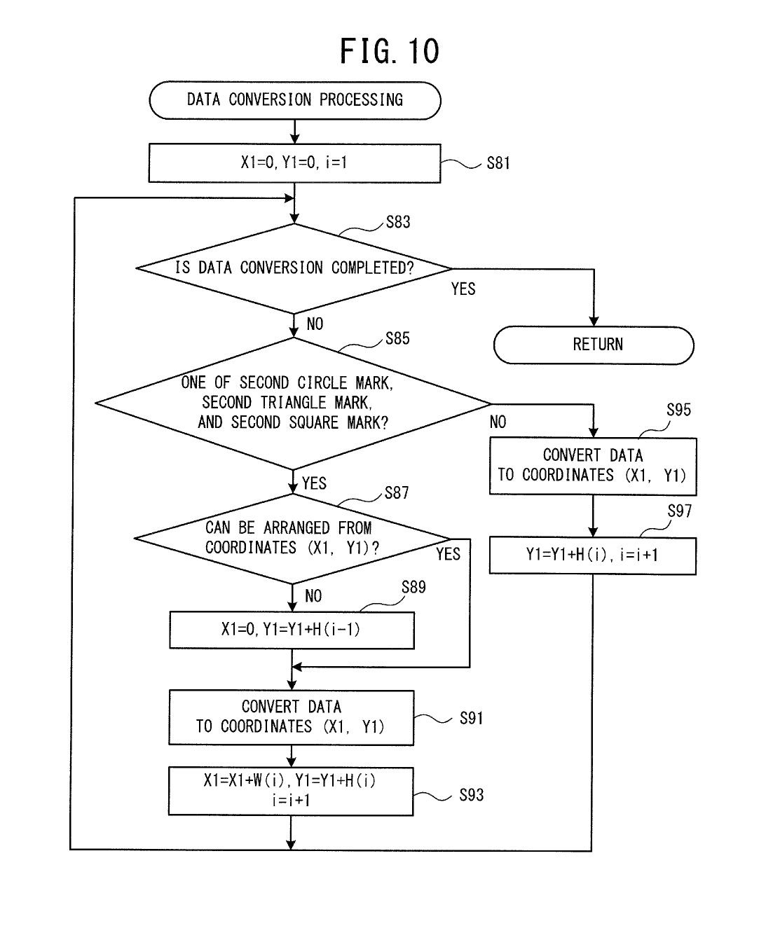

The CPU 21 determines whether or not the line drawing written in the save check box 125 is the first circle mark (step S33). When it is determined that the line drawing is the first circle mark (yes at step S33), the CPU 21 determines whether or not the table 231 is stored in the flash ROM 23 (step S35). When it is determined that the table 231 is stored in the flash ROM 23 (yes at step S35), the CPU 21 performs data conversion processing (refer to FIG. 10) (step S37). The data conversion processing is processing that changes the order and the arrangement of the selected areas and the selected line drawings, based on the records stored in the table 231. The data conversion processing will be described in detail below. After the data conversion processing is completed, the CPU 21 ends the image file creation processing and returns the processing to the main processing (refer to FIG. 7).

On the other hand, when it is determined that the table 231 is not stored in the flash ROM 23 (no at step S35), the CPU 21 creates a plurality of sets of stroke data based on the plurality of sets of line data stored in the second storage area of the RAM 22. Based on each of the created plurality of sets of stroke data, the CPU 21 identifies a plurality of line drawings. The identified line drawings include all the line drawings written in the writing area 123. The CPU 21 creates an image file of an image that includes the identified line drawings (step S39). The CPU 21 stores the created image file in the flash ROM 23. The CPU 21 ends the image file creation processing and returns the processing to the main processing (refer to FIG. 7).

The data conversion processing that is performed by the processing at step S37 in FIG. 8 will be explained with reference to FIG. 10. At step S33 (refer to FIG. 8), it has been determined that the line drawing written in the save check box 125 is the first circle mark. Therefore, the records in the table 231 are arranged from the top to the bottom in the order of the index values, namely, in the order in which the surrounding line drawings are written (step S31, refer to FIG. 8). The CPU 21 sets respective variables X1 and Y1 to 0 and sets a variable i to 1 (step S81). The CPU 21 determines whether or not processing at one of step S91 and step S95 (which will be described below) has been performed for all the records stored in the table 231 (step S83). When the table 231 has a record for which the processing at one of step S91 and step S95 has not been performed, the CPU 21 determines that the processing has not been performed for all of the records (no at step S83). The CPU 21 determines whether or not the specifying mark written in the save check box 125 is one of the second circle mark, the second triangle mark, and the second square mark (step S85). It has been determined at step S33 (refer to FIG. 8) that the specifying mark is the first circle mark (no at step S85), and thus the CPU 21 advances the processing to step S95.

The CPU 21 extracts, from the line data stored in the second storage area of the RAM 22, the stroke data of the selected line drawing that is included in the selected area corresponding to the i-th record (i is the variable) from the top of the table 231. The CPU 21 changes the X coordinate of the i-th record from the top of the table 231 to X1, and changes the Y coordinate to Y1. The CPU 21 converts the extracted stroke data in accordance with the change in each of the X coordinate and the Y coordinate (step S95). The CPU 21 updates the variables Y1 and i (step S97). More specifically, the CPU 21 adds the height (H) of the i-th record to the variable Y1, and thus obtains the updated variable Y1. The CPU 21 updates the variable i by adding 1 to the variable i (step S97). The CPU 21 returns the processing to step S83. The CPU 21 repeats the above-described processing based on the updated variable i.

When it is determined that the processing has been performed for all the records stored in the table 231 (yes at step S83), the CPU 21 creates an image file based on all the stroke data converted by the processing at step S95. The CPU 21 ends the data conversion processing and returns the processing to the image file creation processing (refer to FIG. 8).

As shown in FIG. 8, when it is determined that the line drawing written in the save check box 125 is not the first circle mark (no at step S33), the CPU 21 determines whether or not the line drawing is the second circle mark (step S41). When it is determined that the line drawing is the second circle mark (yes at step S41), the CPU 21 determines whether or not the table 231 is stored in the flash ROM 23 (step S43). When it is determined that the table 231 is stored in the flash ROM 23 (yes at step S43), the CPU 21 performs the data conversion processing (refer to FIG. 10) (step S45). The data conversion processing will be described in detail below. After the data conversion processing is completed, the CPU 21 ends the image file creation processing and returns the processing to the main processing (refer to FIG. 7). On the other hand, when it is determined that the table 231 is not stored in the flash ROM 23 (no at step S43), the CPU 21 creates an image file using the same method as that in the processing at step S39, and stores the created image file in the flash ROM 23 (step S47). The CPU 21 ends the image file creation processing and returns the processing to the main processing (refer to FIG. 7).

The data conversion processing that is performed at step S45 shown in FIG. 8 will be explained with reference to FIG. 10. At step S41 (refer to FIG. 8), it has been determined that the line drawing written in the save check box 125 is the second circle mark. Therefore, the records in the table 231 are arranged from the top to the bottom in the order of the index values, namely, in the order in which the surrounding line drawings are written (step S31, refer to FIG. 8). The CPU 21 sets the respective variables X1 and Y1 to 0 and sets the variable i to 1 (step S81). The CPU 21 determines whether or not the processing at one of step S91 and step S95 (which will be described below) has been performed for all the records stored in the table 231 (step S83). When the table 231 has a record for which the processing at one of step S91 and step S95 has not been performed, the CPU 21 determines that the processing has not been performed for all of the records (no at step S83). The CPU 21 determines whether or not the specifying mark written in the save check box 125 is one of the second circle mark, the second triangle mark, and the second square mark (step S85). It has been determined at step S41 (refer to FIG. 8) that the specifying mark is the second circle mark (yes at step S85), and thus the CPU 21 advances the processing to step S87.

The CPU 21 extracts, from the line data stored in the second storage area of the RAM 22, the stroke data of the selected line drawing that is included in the selected area corresponding to the i-th record (i is the variable) from the top of the table 231. The CPU 21 determines whether or not the X coordinate of the right edge of the selected area corresponding to the i-th record is equal to or less than X3 (=600) when the X coordinate of the i-th record from the top of the table 231 is moved to the variable X1 and the Y coordinate is moved to the variable Y1 (step S87). Specifically, the CPU 21 determines whether or not the width (W) of the i-th record is equal to or less than the value obtained by subtracting X1 from X3 (X3−X1). When it is determined that the width (W) is equal to or less than the value of X3−X1, the CPU 21 determines that the selected area falls within a predetermined range in the X axis direction (yes at step S87). In this case, the CPU 21 advances the processing to step S91. When it is determined that the width (W) is larger than the value of X3−X1, the CPU 21 determines that the selected area does not fall within the predetermined range in the X axis direction (no at step S87). In this case, the CPU 21 sets the variable X1 to 0. Further, the CPU 21 adds the height (H) of the (i−1)-th record to the variable Y1 and thus obtains the updated variable Y1 (step S89). The CPU 21 advances the processing to step S91.

The CPU 21 extracts, from the line data stored in the second storage area of the RAM 22, the stroke data of the selected line drawing that is included in the selected area corresponding to the i-th record (i is the variable) from the top of the table 231. The CPU 21 changes the X coordinate of the i-th record from the top of the table 231 to X1, and changes the Y coordinate to Y1. The CPU 21 converts the extracted stroke data in accordance with the change in each of the X coordinate and the Y coordinate (step S91). The CPU 21 updates the variables X1, Y1, and i (step S93). More specifically, the CPU 21 adds the width (W) of the i-th record to the variable X1, and thus obtains the updated variable X1. Further, the CPU 21 adds the height (H) of the i-th record to the variable Y1, and thus obtains the updated variable Y1. The CPU 21 updates the variable i by adding 1 to the variable i (step S93). The CPU 21 returns the processing to step S83. The CPU 21 repeats the above-described processing based on the updated variable i.

When it is determined that the processing has been performed for all the records (yes at step S83), the CPU 21 creates an image file based on all the stroke data converted by the processing at step S95. The CPU 21 ends the data conversion processing and returns the processing to the image file creation processing (refer to FIG. 8).

As shown in FIG. 8, when it is determined that the line drawing written in the save check box 125 is not the second circle mark (no at step S41), the CPU 21 determines whether or not the line drawing is the first triangle mark (step S49). When it is determined that the line drawing is the first triangle mark (yes at step S49), the CPU 21 determines whether or not the table 231 is stored in the flash ROM 23 (step S51). When it is determined that the table 231 is stored in the flash ROM 23 (yes at step S51), the CPU 21 performs the data conversion processing (refer to FIG. 10) (step S53). The data conversion processing will be described in detail below. After the data conversion processing is completed, the CPU 21 ends the image file creation processing and returns the processing to the main processing (refer to FIG. 7). On the other hand, when it is determined that the table 231 is not stored in the flash ROM 23 (no at step S51), the CPU 21 creates an image file using the same method as that in the processing at step S39 and step S47, and stores the created image file in the flash ROM 23 (step S55). The CPU 21 ends the image file creation processing and returns the processing to the main processing (refer to FIG. 7).

The data conversion processing that is performed at step S53 shown in FIG. 8 will be explained with reference to FIG. 10. At step S49 (refer to FIG. 8), it has been determined that the line drawing written in the save check box 125 is the first triangle mark. Therefore, the records in the table 231 are arranged from the top to the bottom in the order of the values of the remarks, namely, in the order of the numbers that are identified by the number line drawings (step S31, refer to FIG. 8). The CPU 21 performs the processing in the same manner as at step S37 (refer to FIG. 8). When it is determined that the processing has been performed for all the records stored in the table 231 (yes at step S83), the CPU 21 creates an image file based on all the stroke data converted at step S95. The CPU 21 ends the data conversion processing and returns the processing to the image file creation processing (refer to FIG. 8).

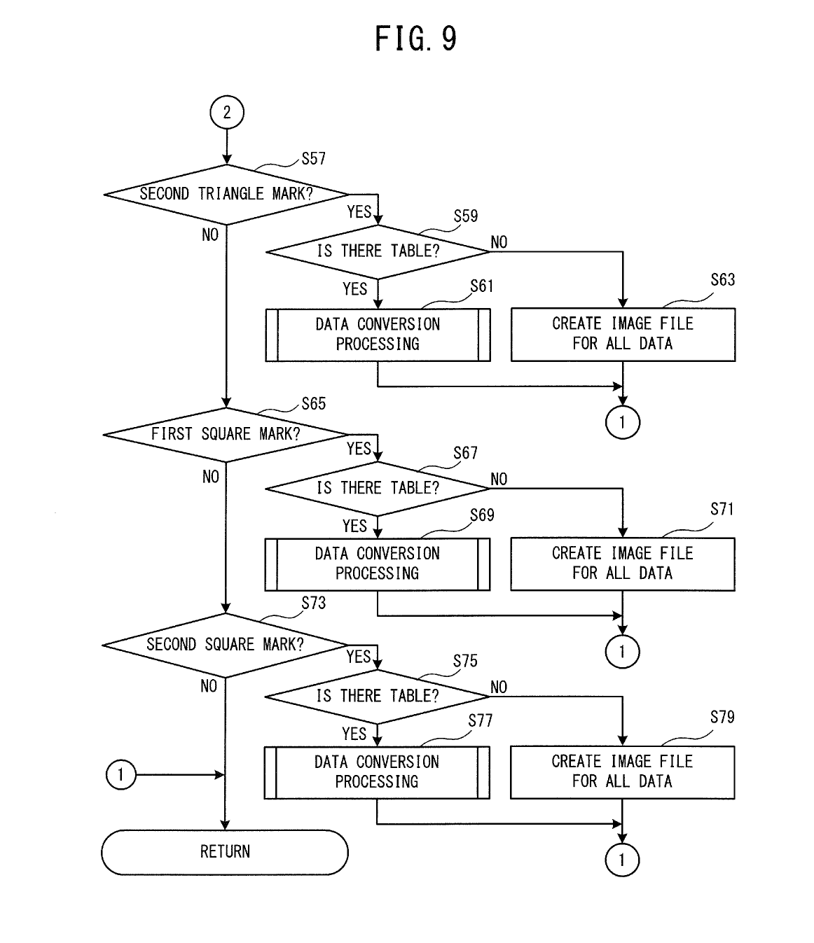

As shown in FIG. 8, when it is determined that the line drawing written in the save check box 125 is not the first triangle mark (no at step S49), the CPU 21 determines whether or not the line drawing is the second triangle mark, as shown in FIG. 9 (step S57). When it is determined that the line drawing is the second triangle mark (yes at step S57), the CPU 21 determines whether or not the table 231 is stored in the flash ROM 23 (step S59). When it is determined that the table 231 is stored (yes at step S59), the CPU 21 performs the data conversion processing (refer to FIG. 10) based on the records stored in the table 231 (step S61). The data conversion processing will be described in detail below. After the data conversion processing is completed, the CPU 21 ends the image file creation processing and returns the processing to the main processing (refer to FIG. 7). On the other hand, when it is determined that the table 231 (refer to FIG. 4) is not stored in the flash ROM 23 (no at step S59), the CPU 21 creates an image file using the same method as that in the processing at step S39, step S47, and step S55 (refer to FIG. 8), and stores the created image file in the flash ROM 23 (step S63). The CPU 21 ends the image file creation processing and returns the processing to the main processing (refer to FIG. 7).

The data conversion processing that is performed at step S61 shown in FIG. 9 will be explained with reference to FIG. 10. At step S57 (refer to FIG. 9), it has been determined that the line drawing written in the save check box 125 is the second triangle mark. Therefore, the records in the table 231 are arranged from the top to the bottom in the order of the values of the remarks, namely, in the order of the numbers that are identified by the number line drawings (step S31, refer to FIG. 8). The CPU 21 performs the processing in the same manner as at step S45 (refer to FIG. 8). When it is determined that the processing has been performed for all the records (yes at step S83), the CPU 21 creates an image file based on all the stroke data converted at step S91. The CPU 21 ends the data conversion processing and returns the processing to the image file creation processing (refer to FIG. 9).

As shown in FIG. 9, when it is determined that the line drawing written in the save check box 125 is not the second triangle mark (no at step S57), the CPU 21 determines whether or not the line drawing is the first square mark (step S65). When it is determined that the line drawing is the first square mark (yes at step S65), the CPU 21 determines whether or not the table 231 is stored in the flash ROM 23 (step S67). When it is determined that the table 231 is stored in the flash ROM 23 (yes at step S67), the CPU 21 performs the data conversion processing (refer to FIG. 10) (step S69). The data conversion processing will be described in detail below. After the data conversion processing is completed, the CPU 21 ends the image file creation processing and returns the processing to the main processing (refer to FIG. 7). On the other hand, when it is determined that the table 231 is not stored in the flash ROM 23 (no at step S67), the CPU 21 creates an image file using the same method as that in the processing at step S39, step S47, step S55, and step S63, and stores the created image file in the flash ROM 23 (step S71). The CPU 21 ends the image file creation processing and returns the processing to the main processing (refer to FIG. 7).

The data conversion processing that is performed at step S69 shown in FIG. 9 will be explained with reference to FIG. 10. At step S65 (refer to FIG. 9), it has been determined that the line drawing written in the save check box 125 is the first square mark. Therefore, the records in the table 231 are arranged from the top to the bottom, in the order of arrangement in the up-down direction on the left page 121L, and in the order of arrangement in the up-down direction on the right page 121R (step S31, refer to FIG. 8). The CPU 21 performs the processing in the same manner as at step S37 and step S53 (refer to FIG. 8). When it is determined that the processing has been performed for all the records (yes at step S83), the CPU 21 creates an image file based on all the stroke data converted at step S95. The CPU 21 ends the data conversion processing and returns the processing to the image file creation processing (refer to FIG. 8).

As shown in FIG. 9, when it is determined that the line drawing written in the save check box 125 is not the first square mark (no at step S65), the CPU 21 determines whether or not the line drawing is the second square mark (step S73). When it is determined that the line drawing is the second square mark (yes at step S73), the CPU 21 determines whether or not the table 231 is stored in the flash ROM 23 (step S75). When it is determined that the table 231 is stored in the flash ROM 23 (yes at step S75), the CPU 21 performs the data conversion processing (refer to FIG. 10) (step S77). The data conversion processing will be described in detail below. After the data conversion processing is completed, the CPU 21 ends the image file creation processing and returns the processing to the main processing (refer to FIG. 7). On the other hand, when it is determined that the table 231 is not stored in the flash ROM 23 (no at step S75), the CPU 21 creates an image file using the same method as that in the processing at step S39, step S47, step S55 (refer to FIG. 8), step S63, and step S71, and stores the created image file in the flash ROM 23 (step S79). The CPU 21 ends the image file creation processing and returns the processing to the main processing (refer to FIG. 7).

As shown in FIG. 9, when it is determined that the line drawing written in the save check box 125 is not the second square mark (no at step S73), the CPU 21 creates an image file using the same method as that in the processing at step S39 (refer to FIG. 8), step S47 (refer to FIG. 8), step S55 (refer to FIG. 8), step S63, step S71, and step S79, and stores the created image file in the flash ROM 23. The CPU 21 ends the image file creation processing and returns the processing to the main processing (refer to FIG. 7).

After the main processing is completed, when a data request command that is wirelessly transmitted from the smart phone 19 is received via the wireless communication portion 24, the CPU 21 wirelessly transmits the image file stored in the flash ROM 23 to the smart phone 19 via the wireless communication portion 24.

When an operation to acquire the image file from the reading device 2 is performed via the touch panel 191, the CPU 41 of the smart phone 19 performs short-range wireless communication with the reading device 2 via the wireless communication portion 44, and transmits the data request command to the reading device 2. The image file stored in the flash ROM 23 of the reading device 2 is wirelessly transmitted from the reading device 2 to the smart phone 19. The CPU 41 receives the image file transmitted wirelessly from the reading device 2, and stores the image file in the flash ROM 43. Based on the image file stored in the flash ROM 43, the CPU 41 causes the display 192 to display an image that includes at least a part of the line drawings written on the paper sheet 121 using the electronic pen 3. The communication when the image file is transmitted from the reading device 2 to the smart phone 19 is not limited to wireless communication, and may be wired communication.

As described above, the CPU 21 of the reading device 2 can determine the order of the plurality of selected areas, in accordance with the ordering method that corresponds to each of the specifying marks (the first circle mark, the second circle mark, the first triangle mark, the second triangle mark, the first square mark, and the second square mark). After the user has written a plurality of line drawings in the writing area 123 of the paper sheet 121, the user may further write the surrounding line drawings. After that, the user may write the specifying mark in the save check box 125. In this manner, the user can order the plurality of selected line drawings included in the plurality of selected areas, in an order desired by the user.

The CPU 21 can determine the arrangement of the plurality of selected areas in accordance with the arrangement method that corresponds to the specifying mark. In this case, with a simple operation of writing the specifying mark in the save check box 125 of the paper sheet 121, the user can arrange the plurality of selected line drawings included in the plurality of selected areas, using an arrangement method desired by the user.

By writing the specifying mark in the save check box 125 of the paper sheet 121, the user may specify, for the reading device 2, the ordering method and the arrangement method of the plurality of selected areas. Therefore, the user can easily issue an instruction to arrange the plurality of selected line drawings using the ordering method and the arrangement method desired by the user.

The CPU 21 operates in the selection mode when a line drawing is written in the selection check box 124. When it is determined that a line drawing has been written in the writing area 123 during the operation in the selection mode, the CPU 21 classifies the written line drawing into one of the surrounding line drawing and the number line drawing. Therefore, with a simple operation of writing a line drawing in the selection check box 124, the user can cause the reading device 2 to recognize the surrounding line drawing and the number line drawing such that they are distinguished from a normal line drawing.

The CPU 21 identifies, as the selected area, the smallest rectangular area that surrounds the surrounding line drawing. In this case, by writing the surrounding line drawing on the paper sheet 121, the user can select the line drawing within the smallest rectangular area that surrounds each of the surrounding line drawings.

Various changes can be made to the above-described embodiment. A part of the above-described main processing may be performed by the CPU 41 of the smart phone 19. For example, in the above-described embodiment, an image file is created by the CPU 21 of the reading device 2, and the created image file is transmitted to the smart phone 19 in response to a request from the smart phone 19. However, the image file may be created by the CPU 41 of the smart phone 19. For example, after the CPU 21 has updated the table 231 at step S31, the CPU 21 need not necessarily perform the processing from step S33 onward. When the CPU 21 receives a data request command transmitted wirelessly from the smart phone 19, the CPU 21 may transmit the table 231 stored in the flash ROM 23 to the smart phone 19. When the CPU 41 of the smart phone 19 receives the table 231 from the reading device 2, the CPU 41 may create an image file based on the received table 231. Based on the created image file, the CPU 41 may cause the display 192 to display an image that includes a line drawing having the same shape as that of the line drawing written on the paper sheet 121 using the electronic pen 3. In this case, it is possible to reduce a processing load on the CPU 21 of the reading device 2. Thus, the image that shows the line drawing written using the electronic pen 3 can be displayed on the display 192 of the smart phone 19 smoothly and in a short time.

The CPU 21 may create only the stroke data without creating an image file and store the created stroke data in the flash ROM 23, in the processing at steps S37, S39, S45, S47, S53, S55, S61, S63, S69, S71, S77, and S79. When the CPU 21 receives a data request command transmitted wirelessly from the smart phone 19, the CPU 21 may transmit the stroke data stored in the flash ROM 23 to the smart phone 19. When the stroke data is received from the reading device 2, the CPU 41 of the smart phone 19 may create an image file based on the received stroke data.

In the above-described embodiment, the CPU 21 associates the surrounding line drawing with the number line drawing that is close to the surrounding line drawing, and stores the associated line drawings in the table 231. When the user writes the number line drawing that corresponds to the surrounding line drawing, immediately after writing the surrounding line drawing, the user may write the corresponding number line drawing. After it is determined that the surrounding line drawing has been written, when the number line drawing is written in a predetermined time period, the CPU 21 may associate the surrounding line drawing with the number line drawing and store the associated line drawings in the table 231.

A common check box, which is used as both the selection check box 124 and the save check box 125, may be printed on the paper sheet 121. In accordance with a form of the line drawing written in the common check box, the CPU 21 may perform determination at steps S15, S17, S19, S31, S33, S41, S49, S57, S65, and S73.

The selection check box 124 and the save check box 125 need not necessarily be provided on the paper sheet 121. The CPU 21 may determine whether or not the line drawing has been written in order to change the operation mode, in accordance with a plurality of positions indicated by the acquired line data. The CPU 21 may determine whether or not to change the operation mode, in accordance with a time period during which the electronic pen 3 is continuously pressed against a specific position on the paper sheet 121. The CPU 21 may change the operation mode when a predetermined input operation is performed with respect to the input portion 25.

When a given line drawing is written in the save check box 125 during the operation in the selection mode, the CPU 21 may arrange the plurality of selected areas using an ordering method and an arrangement method that are specified in advance, among the above-described six combinations of the ordering methods and arrangement methods. The CPU 21 may identify the area surrounded by the surrounding line drawing, as the selected area.

The apparatus and methods described above with reference to the various embodiments are merely examples. It goes without saying that they are not confined to the depicted embodiments. While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. A data processing device comprising:
a detection portion configured to detect a position of a writing tool being close to a detection area, the detection area being configured such that a paper medium can be placed thereon;
a processor; and
a memory configured to store computer-readable instructions, wherein the computer-readable instructions, when executed by the processor, cause the data processing device to perform processes comprising:
acquiring first data, the first data being coordinate data indicating positions, in a first area, that are detected by the detection portion, the first area being a predetermined area in the detection area, and the first data indicating a plurality of line drawings written on the paper medium;
determining whether an instruction to end acquisition of the first data is received;
acquiring second data, the second data being coordinate data indicating positions detected by the detection portion after it is determined that the instruction is received, the second data indicating a plurality of surrounding line drawings, and each of the plurality of surrounding line drawings being a line drawing that surrounds at least a part of the plurality of line drawings;
storing area information in a first storage portion, the area information indicating a plurality of areas that are identified based on the plurality of surrounding line drawings indicated by the acquired second data;
acquiring third data, the third data being coordinate data indicating a position, in a second area, that is detected by the detection portion after the second data is acquired, the second area being a predetermined area that is in the detection area and that is different from the first area, and the third data indicating an ordering method of the plurality of areas; and
determining an order of the plurality of areas using the ordering method indicated by the acquired third data.

2. The data processing device according to claim 1, wherein
the third data further indicates an arrangement method of the plurality of areas, and
the computer-readable instructions, when executed by the processor, further cause the data processing device to perform processes comprising:
determining whether the area information is stored in the first storage portion;
determining an arrangement of the plurality of areas using the arrangement method indicated by the third data and using the determined order, in response to determining that the area information is stored in the first storage portion; and
converting fourth data by arranging the plurality of areas in the determined arrangement, the fourth data being coordinate data indicating a position in each of the plurality of areas, among the positions indicated by the first data, and the fourth data indicating a line drawing written in an area, of the paper medium, that corresponds to each of the plurality of areas.

3. The data processing device according to claim 2, wherein
first identification information is stored in a second storage portion in association with a plurality of arrangement methods of the plurality of areas, the first identification information being information that identifies a plurality of first shapes, and
the determining the arrangement of the plurality of areas includes, in a case where it is determined that a shape identified based on the position indicated by the third data is one of the plurality of first shapes, determining the arrangement of the plurality of areas using, among the plurality of arrangement methods, an arrangement method associated with first identification information that identifies the one of the plurality of first shapes.

4. The data processing device according to claim 1, wherein
second identification information is stored in a third storage portion in association with a plurality of ordering methods of the plurality of areas, the second identification information being information that identifies a plurality of second shapes, and
the determining the order of the plurality of areas includes, in a case where it is determined that a shape identified based on the position indicated by the third data is one of the plurality of second shapes, determining the order of the plurality of areas using, among the plurality of ordering methods, an ordering method associated with second identification information that identifies the one of the plurality of second shapes.

5. The data processing device according to claim 1, wherein
the detection area includes a third area, the third area being a predetermined area that is different from the first area and the second area,
the computer-readable instructions, when executed by the processor, further cause the data processing device to perform a process comprising:
acquiring fifth data, the fifth data being coordinate data indicating a position, in the third area, that is detected by the detection portion, and
the determining whether the instruction is received includes determining that the instruction is received in a case where the fifth data is acquired.

6. The data processing device according to claim 1, wherein
each of the plurality of areas is a smallest rectangular area that surrounds each of the plurality of surrounding line drawings indicated by the second data.
